(19) United States
(12) Patent Application Publication
(10) Pub. No.: US 2024/0351644 A1
(43) Pub. Date: Oct. 24, 2024

(54) VEHICLE CONTROL SYSTEM

(71) Applicant: Honda Motor Co., Ltd., Tokyo (JP)

(72) Inventors: Yasuyuki ONISHI, Saitama (JP); Yasutaka MASUMITSU, Saitama (JP); Jun SAWADA, Saitama (JP); Yoji SUWA, Saitama (JP); Takumi IKAWA, Saitama (JP); Yuya Sugawara, Yokohama City (JP)

(73) Assignee: Honda Motor Co., Ltd., Tokyo (JP)

(21) Appl. No.: 18/590,955

(22) Filed: Feb. 29, 2024

(30) Foreign Application Priority Data
Apr. 24, 2023 (CN) 202310445631.3

(51) Int. Cl. B62D 35/00; B60R 19/48

(52) U.S. Cl. CPC B62D 35/007; B62D 35/02; B62D 37/02

(57) ABSTRACT

A vehicle control system includes a diffuser device disposed on a rear bumper of a vehicle and configured to be movable between a first storage position stored in the rear bumper and a first unfolded position protruding from the rear bumper toward a rear of the vehicle, a spoiler device disposed on a roof plate of the vehicle and configured to be movable between a second storage position stored in the roof plate and a second unfolded position protruding from the roof plate toward the rear of the vehicle, a natural wind detection device disposed on the vehicle to detect a direction of natural wind relative to the vehicle, and a control device disposed on the vehicle and controlling the diffuser device and the spoiler device to move independently in response to the direction of the natural wind.

### CROSS-REFERENCE TO RELATED APPLICATION

This application claims the priority benefit of China application serial no. 202310445631.3, filed on Apr. 24, 2023. The entirety of the above-mentioned patent application is hereby incorporated by reference herein and made a part of this specification.

### BACKGROUND

### Technical Field

The disclosure relates to a vehicle control system.

### Description of Related Art

In recent years, in order to ensure access to affordable, reliable, sustainable, and advanced energy for more people, research and development to improve fuel efficiency that contribute to energy efficiency are being carried out. However, in the technology related to improving fuel efficiency, aerodynamic performance of a vehicle is an issue.

In the conventional technology, a diffuser device may usually be disposed at a rear end of a vehicle body (e.g., a rear bumper), and a spoiler device may be disposed at an upper end of the vehicle body (e.g., a roof plate), so as to improve the aerodynamic performance of the vehicle. A common diffuser device may be a fixed diffuser with a specific shape. Currently, there is also a movable diffuser device, a movable portion of which may move in a forward and backward direction of the vehicle relative to a fixed portion to change a position thereof, thereby adjusting the aerodynamic performance of the vehicle. Similarly, a common spoiler device may be a fixed spoiler with a specific shape. Currently, there is also a movable spoiler device, a movable portion of which may move in the forward and backward direction of the vehicle relative to a fixed portion to change the position thereof, thereby adjusting the aerodynamic performance of the vehicle. However, in order to further improve the aerodynamic performance of the vehicle, it is necessary to consider a direction of natural wind flowing through the vehicle while driving, thereby improving the aerodynamic performance of the vehicle more accurately.

In the disclosure, the aerodynamic performance of the vehicle is improved. Furthermore, it contributes to the energy efficiency.

### SUMMARY

The disclosure provides a vehicle control system, including a diffuser device disposed on a rear bumper of a vehicle and movably disposed between a first storage position stored in the rear bumper and a first unfolded position protruding from the rear bumper toward a rear of the vehicle, a spoiler device disposed on a roof plate of the vehicle and movably disposed between a second storage position stored in the roof plate and a second unfolded position protruding from the roof plate toward the rear of the vehicle, a natural wind detection device disposed on the vehicle to detect a direction of natural wind relative to the vehicle, and a control device disposed on the vehicle and controlling the diffuser device and the spoiler device to move independently in response to the direction of the natural wind.

In order for the aforementioned features and advantages of the disclosure to be more comprehensible, embodiments accompanied with drawings are described in detail below.

### BRIEF DESCRIPTION OF THE DRAWINGS

FIG. 1 is a schematic top view of a vehicle to which a vehicle control system is applied according to an embodiment of the disclosure.

FIG. 2 is a schematic view of an electrical structure of the vehicle control system shown in FIG. 1.

FIG. 3 is a schematic view of a diffuser device used in the vehicle control system shown in FIG. 1.

FIG. 4 is a schematic view of a spoiler device used in the vehicle control system shown in FIG. 1.

FIGS. 5A to 5D are schematic views of the diffuser device and the spoiler device used in the vehicle control system shown in FIG. 1 when in respective storage positions and unfolded positions thereof.

FIG. 6 is a schematic view of an operation of the vehicle control system shown in FIG. 1 detecting an angle based on a direction of natural wind.

FIG. 7 is a schematic view of an operation process of the vehicle control system shown in FIG. 1 controlling the diffuser device and the spoiler device in response to the direction of the natural wind.

FIG. 8 is a graph in which the vehicle control system shown in FIG. 1 obtains a first preset angle and a second preset angle by obtaining an air resistance value of the vehicle relative to the direction of the natural wind through a simulation or an experiment.

### DETAILED DESCRIPTION OF DISCLOSED EMBODIMENTS

The disclosure provides a vehicle control system, which may improve aerodynamic performance of a vehicle.

In an embodiment of the disclosure, the control device changes states of the diffuser device and the spoiler device in response to the direction of the natural wind. The control device controls the diffuser device to move to the first unfolded position and controls the spoiler device to move to the second unfolded position in a first state, controls the diffuser device to move to the first unfolded position and controls the spoiler device to move to the second storage position in a second state, and controls the diffuser device to move to the first storage position and controls the spoiler device to move to the second unfolded position in a third state.

In an embodiment of the disclosure, the natural wind detection device detects an angle of the direction of the natural wind relative to a straight direction of the vehicle.

In an embodiment of the disclosure, the natural wind detection device detects a pressure value of the natural wind, and the angle of the direction of the natural wind relative to the straight direction of the vehicle is obtained by calculating the pressure value.

In an embodiment of the disclosure, when the angle of the direction of the natural wind relative to the straight direction of the vehicle is less than a first preset angle, the control device controls the diffuser device to move to the first unfolded position and controls the spoiler device to move to the second storage position. When the angle of the direction of the natural wind relative to the straight direction of the vehicle is greater than the first preset angle and less than a second preset angle, the control device controls the diffuser device to move to the first unfolded position and control the spoiler device to move to the second unfolded position. When the angle of the direction of the natural wind relative to the straight direction of the vehicle is greater than the second preset angle, the control device controls the diffuser device to move to the first storage position and controls the spoiler device to move to the second unfolded position.

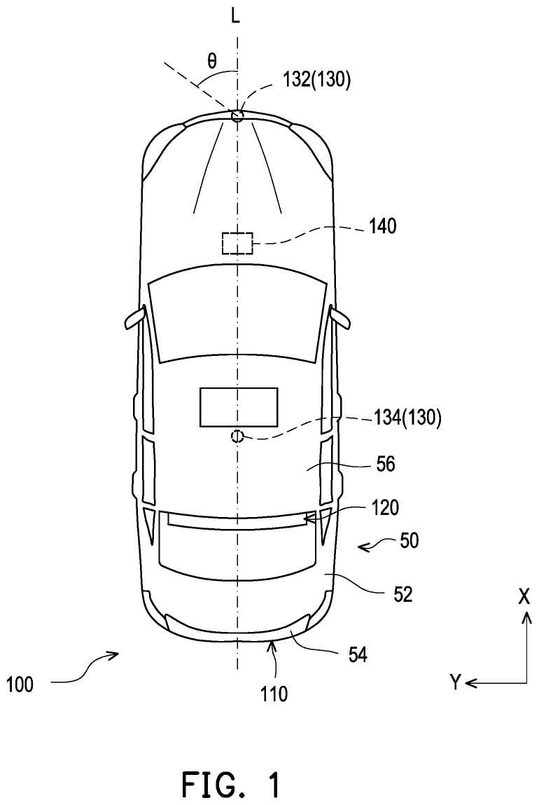

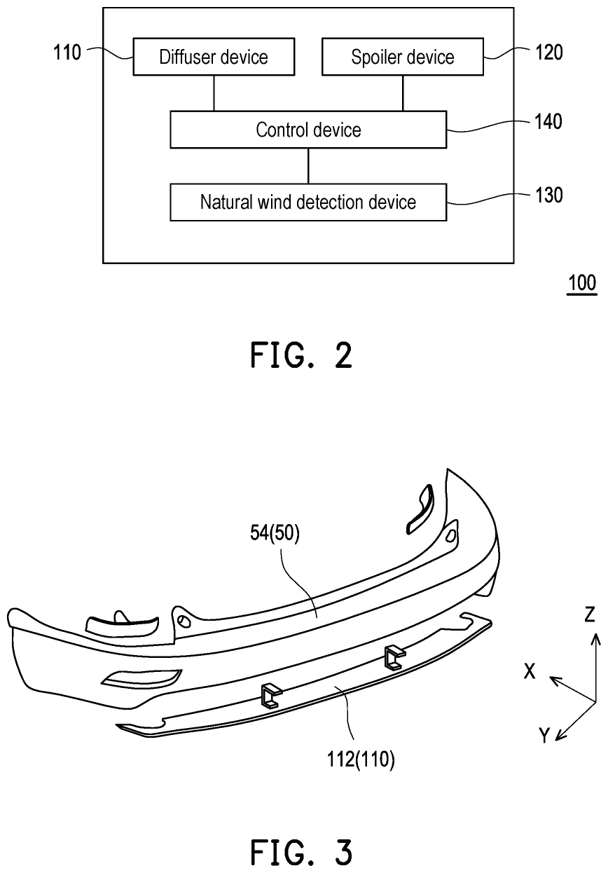

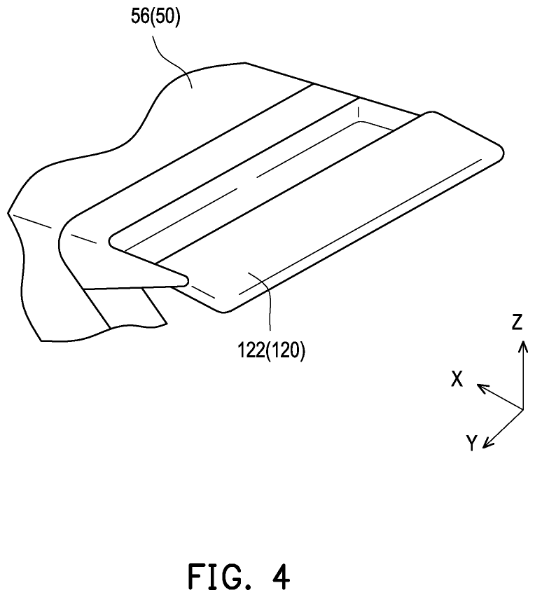

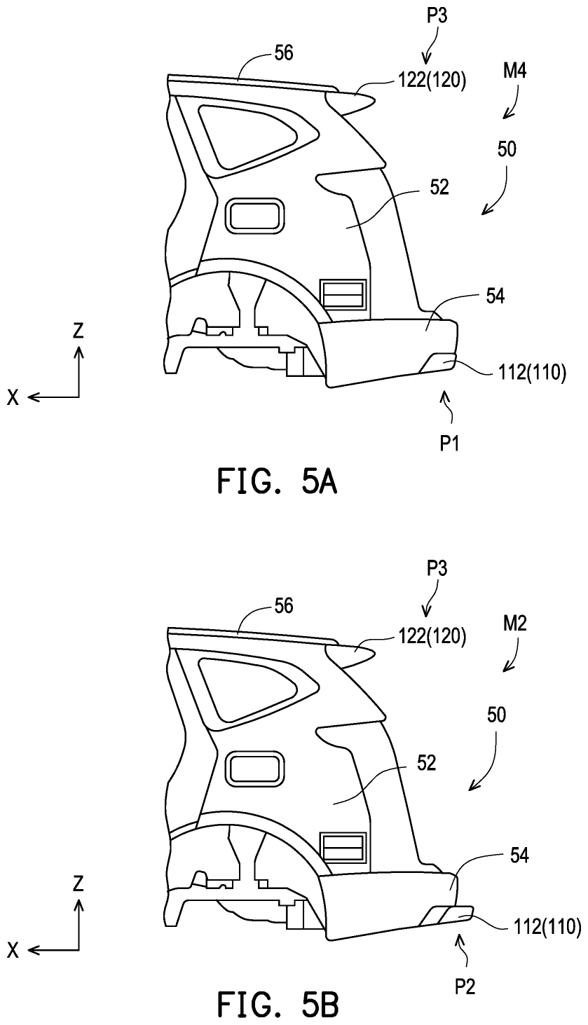

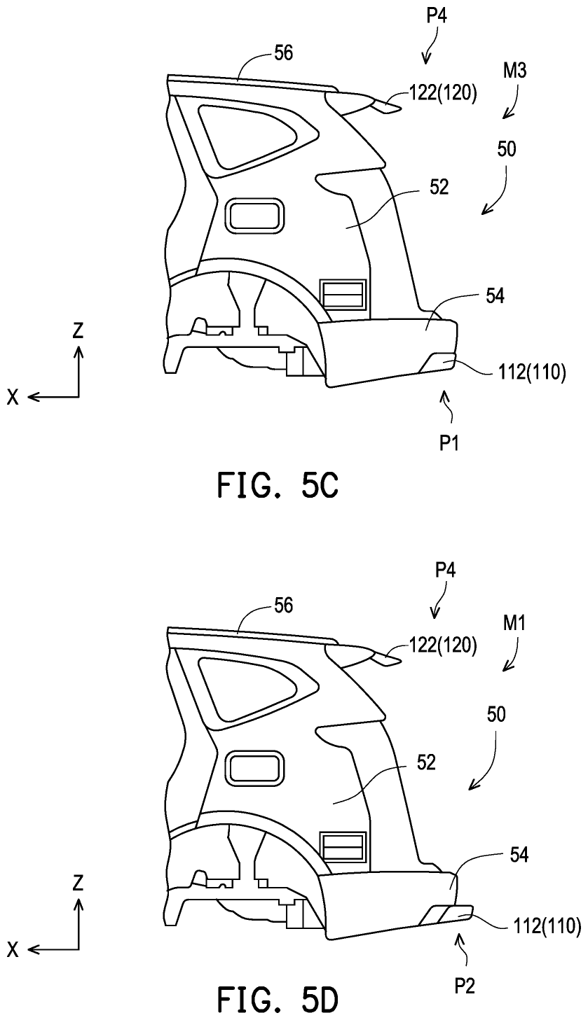

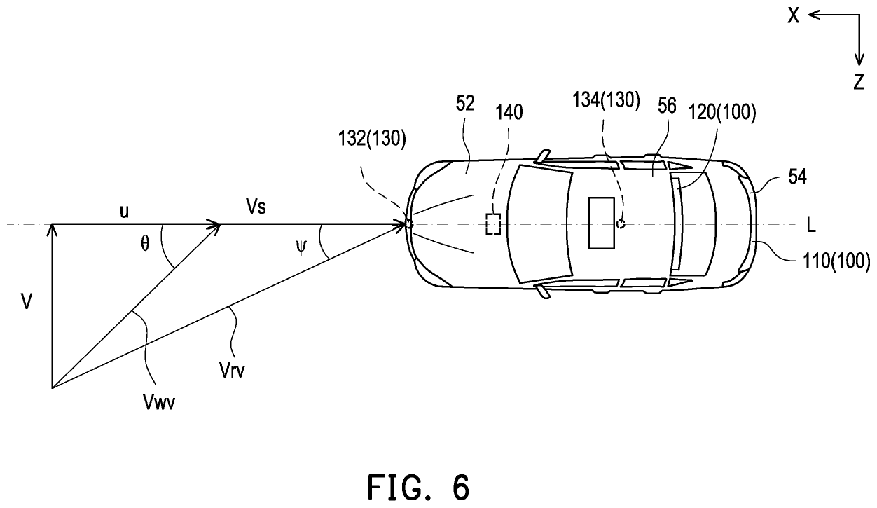

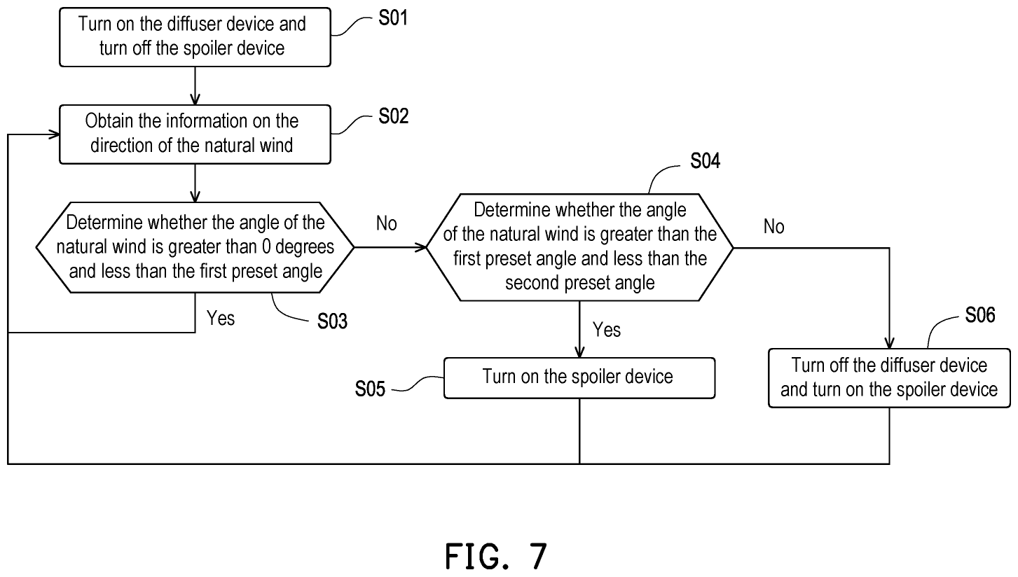

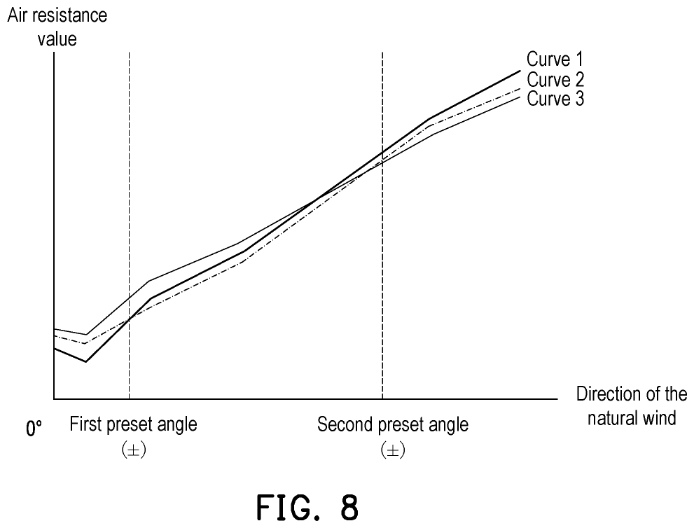

Based on the above, in the vehicle control system of the disclosure, the diffuser device is movably disposed between the first storage position stored in the rear bumper and the first unfolded position protruding from the rear bumper toward the rear of the vehicle. The spoiler device is movably disposed between the second storage position stored in the roof plate and the second unfolded position protruding from the roof plate toward the rear of the vehicle. The natural wind detection device detects the direction of the natural wind relative to the vehicle, and the control device controls the diffuser device and the spoiler device to move independently in response to the direction of the natural wind. In this way, the diffuser device and the spoiler device may respectively move to the respective storage positions or unfolded positions thereof in response to the direction of the natural wind, thereby adjusting the airflow guided by the diffuser device and the spoiler device more accurately according to the actual conditions. Accordingly, the vehicle control system in the disclosure may improve the aerodynamic performance of the vehicle. Reference will now be made in detail to the exemplary embodiments of the disclosure, and examples of the exemplary embodiments are illustrated in the accompanying drawings. FIG. 1 is a schematic top view of a vehicle to which a vehicle control system is applied according to an embodiment of the disclosure. FIG. 2 is a schematic view of an electrical structure of the vehicle control system shown in FIG. 1. FIG. 3 is a schematic view of a diffuser device used in the vehicle control system shown in FIG. 1. FIG. 4 is a schematic view of a spoiler device used in the vehicle control system shown in FIG. 1. FIGS. 5A to 5D are schematic views of the diffuser device and the spoiler device used in the vehicle control system shown in FIG. 1 when in respective storage positions and unfolded positions thereof. FIG. 6 is a schematic view of an operation of the vehicle control system shown in FIG. 1 detecting an angle based on a direction of natural wind. FIG. 7 is a schematic view of an operation process of the vehicle control system shown in FIG. 1 controlling the diffuser device and the spoiler device in response to the direction of the natural wind. FIG. 8 is a graph in which the vehicle control system shown in FIG. 1 obtains a first preset angle and a second preset angle by obtaining an air resistance value of the vehicle relative to the direction of the natural wind through a simulation or an experiment. An application, a specific structure, etc. of a vehicle control system 100 in this embodiment will be described below with reference to FIGS. 1 to 8. The forward and backward of the vehicle described in the following refers to, for example, a forward and backward direction X in the drawings with a direction pointed by an arrow as the front. The left and right direction of the vehicle refers to, for example, a left and right direction Y in the drawings with a direction pointed by the arrow as the left. The upper and lower direction of the vehicle refers to, for example, an upper and lower direction Z in the drawings with a direction pointed by the arrow is upward. However, this is only one example of the disclosure, and the disclosure is not limited thereto.

Referring to FIGS. 1 to 4, in this embodiment, the vehicle control system 100 includes a diffuser device 110, a spoiler device 120, a natural wind detection device 130, and a control device 140. The diffuser device 110 and the spoiler device 120 are adapted to be disposed on a vehicle body 52 of a vehicle 50 as exterior devices to stabilize airflow flowing through the vehicle 50, thereby improving aerodynamic performance of the vehicle 50. The diffuser device 110 is disposed on a rear bumper 54 disposed at a rear end of the vehicle body 52 of the vehicle 50, and the diffuser device 110 is movably disposed between a first storage position P1 stored in the rear bumper 54 and a first unfolded position P2 protruding from the rear bumper 54 toward a rear (i.e., a direction opposite to the direction pointed by the arrow in the forward and backward direction X) of the vehicle 50 (as shown in FIGS. 5A to 5D). Similarly, the spoiler device 120 is disposed on a roof plate 56 disposed on an upper end of the vehicle body 52 of the vehicle 50, and the spoiler device 120 is movably disposed between a second storage position P3 stored in the roof plate 56 and a second unfolded position P4 protruding from the roof panel 56 toward the rear of the vehicle 50 (as shown in FIGS. 5A to 5D). In addition, as shown in FIG. 1, the natural wind detection device 130 is disposed on the vehicle 50 to detect a direction of natural wind relative to the vehicle 50. The control device 140 is disposed on the vehicle 50 and controls the diffuser device 110 and the spoiler device 120 to move independently in response to the direction of the natural wind. However, in the disclosure, the application of the vehicle control system 100 to the vehicle 50 is not limited, which may be adjusted according to requirements.

Specifically, in this embodiment, the diffuser device 110 includes, for example, a long and narrow diffuser body 112 (e.g., a single plate or a combination of multiple plates) extending along the left and right direction Y of the vehicle 50 (e.g., as shown in FIG. 3) and spanning left and right sides of the vehicle 50 and a movable mechanism (e.g., a link mechanism, a sliding mechanism, etc.) that is not shown, and is electrically connected to the control device 140 to be movable between the first storage position P1 and the first unfolded position P2 under the control of the control device 140. For example, under the condition that a vehicle speed of the vehicle 50 does not reach a first predetermined speed, etc., when the diffuser device 110 moves to the first storage position P1 under the control of the control device 140, the diffuser body 112 of the diffuser device 110 is stored in the rear bumper 54 as a portion of the rear bumper 54. Furthermore, for example, under the condition that the vehicle speed of the vehicle 50 is equal to or higher than the first predetermined speed, etc., when the diffuser device 110 moves to the first unfolded position P2 under the control of the control device 140, the diffuser body 112 of the diffuser device 110 is driven by the movable mechanism to protrude from the rear bumper 54 toward the rear of the vehicle 50, thereby changing the airflow around the diffuser device 110. The diffuser device 110 refers to a rear diffuser device disposed on the rear bumper 54 disposed on the vehicle body 52 of the vehicle 50. However, in the disclosure, a specific structure of the diffuser device 110 is not limited, which may be adjusted according to the requirements. For example, the control device 140 is configured to electrically drive the movable mechanism to move the diffuser body 112. However, the disclosure is not limited thereto. A mechanism for absorbing driving wind or the natural wind of the vehicle 50 may be disposed, and the diffuser body 112 may be moved by physically driving the movable mechanism using changes in an air speed.

Similarly, in this embodiment, the spoiler device 120 includes, for example, a long and narrow spoiler body 122 (e.g., a single plate or a combination of multiple plates) extending along the left and right direction Y of the vehicle 50 (e.g., as shown in FIG. 4) and spanning the left and right sides of the vehicle 50 and the movable mechanism (for example, the link mechanism, a sliding mechanism, etc.) that is not shown, and is electrically connected to the control device 140 to be movable between the second storage position P3 and the second unfolded position P4 under the control of the control device 140. For example, under the condition that the vehicle speed of the vehicle 50 does not reach a second predetermined speed, etc., when the spoiler device 120 moves to the second storage position P3 under the control of the control device 140, the spoiler body 122 of the spoiler device 120 is stored at a rear end of the roof plate 56 as a portion of the roof plate 56. Furthermore, for example, under the condition that the vehicle speed of the vehicle 50 is equal to or higher than the second predetermined speed, etc., when the spoiler device 120 moves to the second unfolded position P4 under the control of the control device 140, the spoiler body 122 of the spoiler device 120 is driven by the movable mechanism to protrude from the rear end of the roof plate 56 toward the rear of the vehicle 50, thereby changing the airflow around the spoiler device 120. The spoiler device 120 refers to a rear spoiler device disposed on the rear end of the roof plate 56 disposed on the vehicle body 52 of the vehicle 50. However, in the disclosure, a specific structure of the spoiler device 120 is not limited, which may be adjusted according to the requirements. For example, the control device 140 is configured to electrically drive the movable mechanism to move the spoiler body 122. However, the disclosure is not limited thereto. The mechanism for absorbing the driving wind or the natural wind of the vehicle 50 may be disposed, and the spoiler body 112 may be moved by physically driving the movable mechanism using the changes in the air speed. In addition, the second predetermined speed of moving the spoiler device 120 and the first predetermined speed of moving the diffuser device 110 may be the same or different.

Furthermore, in this embodiment, as shown in FIG. 1, the natural wind detection device 130 detects the direction of the natural wind relative to the vehicle 50. For example, it refers to an angle θ of the direction of the natural wind relative to a straight direction (i.e., in front of the forward and backward direction X) of the vehicle 50 detected by the natural wind detection device 130. Preferably, the natural wind detection device 130 is, for example, a sensor, and includes a front portion detection device 132 disposed in the middle of a front end portion (i.e., a front end pointed by the arrow corresponding to the forward and backward direction X) of the vehicle 50 and a top portion detection device 134 disposed at a center of a top portion (e.g., the roof plate 56) of the vehicle 50, so as to detect a pressure value (e.g., correspondingly detecting pressure values Pc and Pt) of the natural wind relative to the vehicle 50. Therefore, the natural wind detection device 130 detects the pressure value of the natural wind, and the angle θ of the direction of the natural wind relative to the straight direction of the vehicle 50 is obtained by calculating the pressure value. For example, the direction of the natural wind relative to the vehicle 50 is calculated based on the pressure values Pc and Pt in a detection result through a calculation component that is not shown (e.g., formed by a portion of the control device 140). However, in the disclosure, the number, positions of configuration, and implementation means of the natural wind detection devices 130 are not limited, which may be adjusted according to the requirements.

In addition, as shown in FIGS. 1 and 2, the control device 140 is, for example, a central control unit or a processing unit disposed in the vehicle 50, and is electrically connected to the natural wind detection device 130. In this way, the detection result detected by the natural wind detection device 130 may be transmitted to the control device 140 as an electrical signal. If the detection result of the natural wind detection device 130 is the direction of the natural wind relative to the vehicle 50, the control device 140 may control the movement of the diffuser device 110 and the spoiler device 120 in response to the detected direction of the natural wind. If the detection result of the natural wind detection device 130 is the angle θ of the direction of the natural wind relative to the straight direction of the vehicle 50 or the pressure value of the natural wind relative to the vehicle 50, the control device 140 may first perform calculation on the detection result to obtain the direction of the natural wind relative to the vehicle 50, and then control the movement of the diffuser device 110 and the spoiler device 120 in response to the obtained direction of the natural wind. In addition, the movement of the diffuser device 110 between the first storage position P1 and the first unfolded position P2 and the movement of the spoiler device 120 between the second storage position P3 and the second unfolded position P4 may be controlled independently by the control device 140. However, in the disclosure, the implementation means of the control device 140 is not limited, which may be adjusted according to the requirements.

Furthermore, as shown in FIGS. 1 and 6, in this embodiment, the direction of the natural wind relative to the vehicle 50 is detected by the natural wind detection device 130 to detect whether there is cross wind in the natural wind flowing through the vehicle 50. That is, it is detected whether the angle θ of the direction of the natural wind relative to the straight direction (i.e., in front of the forward and backward direction X) of the vehicle 50 is greater than a preset angle. The angle θ of the direction of the natural wind relative to the straight direction of the vehicle 50 is defined, for example, with a center extension line L of the vehicle 50 as a center. The central extension line L extends along the forward and backward direction X corresponding to the straight direction of the vehicle 50. A right side of the central extension line L has a positive value, and a left side has a negative value. When the angle θ of the direction of the natural wind relative to the straight direction of the vehicle 50 is 0 degrees, it may be regarded that the direction of the natural wind is parallel to the straight direction of the vehicle 50 (that is, the direction of the natural wind is parallel to the forward and backward direction X). In this way, the vehicle control system 100 may detect the direction of the natural wind relative to the vehicle 50 flowing through the vehicle 50 during a driving process of the vehicle 50 through the natural wind detection device 130, so as to control the positions of the diffuser device 110 and spoiler device 120 through the control device 140 during the driving process of the vehicle 50. Although the above content points out that the angle θ of the direction of the natural wind relative to the straight direction of the vehicle 50 is positive on the right side of the central extension line L and negative on the left side, subsequent descriptions (e.g., a judgment formula in the operation process) about the angle θ of the direction of the natural wind relative to the straight direction of the vehicle 50 are set based on an absolute value (regardless of the left and right directions) of a magnitude of the angle θ. However, the disclosure is not limited thereto, which may be adjusted according to the requirements.

As an example, based on pressure data (e.g., the pressure values detected by the front portion detection device 132 and the top portion detection device 134) detected by the natural wind detection device 130 and a relative air speed (related to the speed of vehicle 50) of the vehicle 50 during the driving process, steps for obtaining information on a wind speed and a wind direction of the natural wind acting on the vehicle 50 are described below.

First, as shown in FIG. 6, the wind speed of the natural wind is set to Vwv. Velocity components of the natural wind are set to u and v. The vehicle speed of the vehicle 50 is set to Vs. The relative air speed of the vehicle 50 during the driving process is set to Vrv. An angle that the relative air speed Vrv presents relative to the center extension line L of the vehicle 50, that is, a yaw angle, is set to ψ.

Next, the Bernoulli's theorem is used to establish Formula (1) for converting a dynamic pressure value into the wind speed, where p is an air density (the air density p may be additionally detected, or an appropriate value may be selected according to the requirements), Vrv is the relative air speed (related to the speed of the vehicle 50) of the vehicle 50 during the driving process, the pressure value Pc is a pressure value detected by the front portion detection device 132 (shown in FIG. 1) disposed in the middle of the front end portion of the vehicle 50, and the pressure value Pt is a pressure value detected by the top portion detection device 134 (shown in FIG. 1) disposed at the center of the top portion of the vehicle 50.

$$ρ \times {( V r v )}^{2} / 2 = P c - P t \qquad Formula ( 1 )$$

Furthermore, Formula (1) is rewritten into Formula (2) to obtain the relative air speed Vrv.

$$V r v = \sqrt{2 ( P c - Pt ) / ρ} \qquad Formula ( 2 )$$

Finally, using the relative air speed Vrv, the yaw angle ψ of the relative air speed Vrv relative to the vehicle 50, and the vehicle speed Vs of the vehicle 50, the velocity components u and v of the natural wind may be obtained from Formula (3).

$$\begin{matrix}u = Vw v x = Vrv cos ψ - V s \\ v = Vw v y = Vrv sin ψ\end{matrix} \qquad Formula ( 3 )$$

Thus, magnitudes of the velocity components u and v of the natural wind may be obtained, thereby obtaining the wind speed Vwv of the natural wind acting on the vehicle 50 and the angle θ of the direction of the natural wind relative to the straight direction of the vehicle 50 (equivalent to the wind direction of the natural wind).

However, the above description is only one of the processes for obtaining the wind direction of the natural wind acting on the vehicle 50 through the natural wind detection device 130 shown in FIGS. 1 and 6 and relevant conditions (e.g., the vehicle speed) of the vehicle 50. In other embodiments not shown, the process of obtaining the wind direction of the natural wind may be adjusted according to a type of the disposed natural wind detection device 130 and the vehicle speed of the vehicle 50 (whether it is traveling or not). However, the disclosure is not limited thereto.

Furthermore, in this embodiment, the direction of the natural wind relative to the vehicle 50 (whether there is cross wind) is detected to control the movement of the diffuser device 110 and the spoiler device 120 in response to the direction of the natural wind. Furthermore, the control device 140 changes states of the diffuser device 110 and the spoiler device 120 in response to the direction of the natural wind. The control device 140 controls the diffuser device 110 to move to the first unfolded position P2 and controls the spoiler device 120 to move to the second unfolded position P4 in a first state M1 (as shown in FIG. 5D), controls the diffuser device 110 to move to the first unfolded position P2 and controls the spoiler device 120 to move to the second storage position P3 in a second state M2 (as shown in FIG. 5B), and controls the diffuser device 110 to move to the first storage position P1 and controls the spoiler device 120 Move to the second unfolded position P4 in a third state M3 (shown in FIG. 5C). That is to say, the control device 140 controls at least one of the diffuser device 110 and the spoiler device 120 to move to the unfolded position thereof in response to the direction of the natural wind. However, the control device 140 may also control the diffuser device 110 to move to the first storage position P1 and control the spoiler device 120 to move to the second storage position P3 in a fourth state M4 (as shown in FIG. 5A) in response to the direction of the natural wind to control both of the diffuser device 110 and the spoiler device 120 to move to the storage positions thereof. The movement of the diffuser device 110 and the spoiler device 120 may be controlled independently. In the disclosure, the positions of the diffuser device 110 and the spoiler device 120 are not limited, which may be adjusted according to the requirements.

As an example, when the angle θ of the direction of the natural wind relative to the straight direction of the vehicle 50 is less than the first preset angle, the control device 140 controls the diffuser device 110 to move to the first unfolded position P2 and controls the spoiler device 120 to move to the second storage position P3 (the second state M2 as shown in FIG. 5B). When the angle θ of the direction of the natural wind relative to the straight direction of the vehicle 50 is greater than the first preset angle and less than the second preset angle, the control device 140 controls the diffuser device 110 to move to the first unfolded position P2 and controls the spoiler device 120 to move to the second unfolded position P4 (the first state M1 shown in FIG. 5D). When the angle θ of the direction of the natural wind relative to the straight direction of the vehicle 50 is greater than the second preset angle, the control device 140 controls the diffuser device 110 to move to the first storage position P1 and controls the spoiler device 120 to move to the second unfolded position P4 (the third state M3 shown in FIG. 5C).

That is to say, when the cross wind is small (the angle θ is less than the first preset angle), preferably, as in the second state M2 shown in FIG. 5B, the diffuser device 110 is moved to the first unfolded position P2 (that is, the diffuser device 110 is turned on), and the spoiler device 120 is moved to the second storage position P3 (that is, the spoiler device 120 is turned off), so as to improve the aerodynamic performance of the vehicle 50. Similarly, when the cross wind is moderate (the angle θ is between the first preset angle and the second preset angle), preferably, as shown in the first state M1 in FIG. 5D, the diffuser device 110 is moved to the first unfolded position P2 (that is, the diffuser device 110 is turned on), and the spoiler device 120 is moved to the second unfolded position P4 (that is, the spoiler device 120 is turned on), so as to improve the aerodynamic performance of the vehicle 50. Correspondingly, when the cross wind is strong (the angle θ is greater than the second preset angle), preferably, as shown in the third state M3 shown in FIG. 5C, the diffuser device 110 is moved to the first storage position P1 (that is, the diffuser device 110 is turned off), and the spoiler device 120 is moved to the second unfolded position P4 (that is, the spoiler device 120 is turned on), so as to improve the aerodynamic performance of the vehicle 50. Furthermore, while considering the aerodynamic performance of the vehicle 50, an impact of the cross wind on the air resistance value is further considered. Therefore, the first preset angle and the second preset angle are preferably set to avoid a phenomenon of lowering the air resistance value caused by the cross wind.

Here, as shown in FIG. 8, it is desired to obtain the air resistance value of the vehicle 50 relative to the direction of the natural wind through the simulation or the experiment, so as to obtain the first preset angle and the second preset angle in advance. A curve 1 refers to a state where the diffuser device 110 moves to the first unfolded position P2 (turned on), and the spoiler device 120 moves to the second storage position P3 (turned off). A curve 2 refers to a state where the diffuser device 110 moves to the first unfolded position P2 (turned on), and the spoiler device 120 moves to the second unfolded position P4 (turned on). A curve 3 refers to a state where the diffuser device 110 moves to the first storage position P1 (turned off), and the spoiler device 120 moves to the second unfolded position P4 (turned on). However, the disclosure is not limited thereto. The first preset angle is, for example, plus or minus 2 degrees (positive to the right and negative to the left) centered on the center extension line L of the vehicle 50, and the second preset angle is, for example, plus or minus 10 degrees centered on the central extension line L of the vehicle 50. However, the first preset angle and the second preset angle may be adjusted depend on conditions such as the specific structures of the diffuser device 110 and the spoiler device 120, relative positions between the two, and relative positions between the two and the vehicle body 52, and an appearance of the vehicle 50. However, the disclosure is not limited thereto.

Preferably, in this embodiment, an operation process of the vehicle control system 100 controlling the diffuser device 110 and the spoiler device 120 according to the direction of the natural wind is shown in FIG. 7. First, in step S01, when the vehicle speed of the vehicle 50 is above the first predetermined speed and above the second predetermined speed, the diffuser device 110 is turned on, and the spoiler device 120 is turned off. That is, the control device 140 controls the diffuser device 110 to move to the first unfolded position P2 and controls the spoiler device 120 to move to the second storage position P3 (the second state M2 as shown in FIG. 5B). Next, in step S02, the information on the direction of the natural wind is obtained. For example, the angle θ of the direction of the natural wind relative to the straight direction of the vehicle 50 is obtained. Next, in step S03, it is determined whether the angle θ of the natural wind is greater than 0 degrees and less than the first preset angle. If it is determined that the angle θ of the natural wind is greater than 0 degrees and less than the first preset angle (Yes in step S03), the states of the diffuser device 110 and the spoiler device 120 are not changed. That is, the diffuser device 110 is maintained in the turned-on state (i.e., maintaining the diffuser device 110 in the first unfolded position P2), and the spoiler device 120 is maintained in the turned-off state (i.e., maintaining the spoiler device 120 in the second storage position P3). After the preset time has elapsed, step S02 is returned again to obtain the information on the direction of the natural wind. Correspondingly, if it is determined that the angle θ of the natural wind is greater than the first preset angle (No in step S03), in step S04, it is determined whether the angle θ of the natural wind is greater than the first preset angle and less than the second preset angle.

Next, in step S04, if it is determined that the angle θ of the natural wind is greater than the first preset angle and less than the second preset angle (Yes in step S04), in step S05, the spoiler device 120 is further turned on. That is, the control device 140 changes the state of the spoiler device 120, while controlling the diffuser device 110 to maintain the first unfolded position P2 and controlling the spoiler device 120 to move to the second unfolded position P4 (the first state M1 shown in FIG. 5D). After the preset time has elapsed, step S02 is returned again to obtain the information on the direction of the natural wind. Correspondingly, if it is determined that the angle θ of the natural wind is greater than the second preset angle (No in step S04), in step S06, the diffuser device 110 is turned off, and the spoiler device 120 is turned on. That is, the control device 140 changes the states of the diffuser device 110 and the spoiler device 120, while controlling the diffuser device 110 to move to the first storage position P1 and controlling the spoiler device 120 to move to the second unfolded position P4 (the third state M3 as shown in FIG. 5C). After the preset time has elapsed, step S02 is returned again to obtain the information on the direction of the natural wind. After step S03, step S05, and step S06 are completed as described above, and step S02 is returned again after the preset time has elapsed to obtain the information on the direction of the natural wind, the above process may be referred again to determine the relative relationship between the angle θ of the natural wind and the first preset angle and the second preset angle to decide whether to turn on or turn off the diffuser device 110 and turn on or turn off the spoiler device 120 (the turning on or turning off of the diffuser device 110 and the spoiler device 120 are controlled independently) until the vehicle 50 stops traveling.

In the above process, it is decided whether to turn on or turn off the diffuser device 110 (that is, the diffuser device 110 is controlled to move to the first unfolded position P2 or the first storage position P1) and to turn on or turn off the spoiler device 120 (that is, the spoiler device 120 is controlled to move to the second unfolded position P4 or the second storage position P3) based on the first preset angle and the second preset angle. However, in other embodiments not shown, it is also possible to control the diffuser device 110 to move to multiple positions between the first storage position P1 and the first unfolded position P2 based on multiple preset angles and to control the spoiler device 120 to move to multiple positions (multi-stage control) between the second storage position P3 and the second unfolded position P4 based on the preset angles. Therefore, the airflow guided by the diffuser device 110 and the spoiler device 120 may be adjusted more accurately.

In addition, the above process is to first turn on the diffuser device 110 and turn off the spoiler device 120, and decide to maintain the turned-on state of the diffuser device 110 or turn off the diffuser device 110 and decide to maintain the turned-off state of the spoiler device 120 or turn on the spoiler device 120 based on the information on the direction of the natural wind and judgment results of the angle θ of the natural wind, the first preset angle, and the second preset angle after the vehicle 50 starts traveling, and the information on the direction of the natural wind is obtained. However, in other embodiments not shown, the diffuser device 110 may be turned off, and the spoiler device 120 may be turned on first. After the vehicle 50 starts traveling, and the information on the direction of the natural wind is obtained, it is decided to maintain the turned-off state of the diffuser device 110 or turn on the diffuser device 110 and decide to maintain the turned-on state of the spoiler device 120 or turn off the spoiler device 120 based on the information on the direction of the natural wind and the judgment results of the angle θ of the natural wind, the first preset angle, and the second preset angle. In addition, as long as the diffuser device 110 and the spoiler device 120 may be moved between the respective storage positions and unfolded positions thereof, it is also possible to maintain the diffuser device 110 and the spoiler device 120 in a middle position between the respective storage positions and unfolded positions thereof in response to the conditions of the driving wind or the natural wind.

Furthermore, the above process does not mention the conditions under which the control device 140 controls the diffuser device 110 to move to the first storage position P1 and controls the spoiler device 120 to move to the second storage position P3 (as shown in FIG. 5A) in the fourth state M4. However, in other embodiments not shown, the control device 140 may also change the states of the diffuser device 110 and the spoiler device 120 when the angle θ of the natural wind is greater than a third preset angle that is not shown, and turn off the diffuser device 110 and turn off the spoiler device 120 in the fourth state M4 as shown in FIG. 5A (that is, the diffuser device 110 is controlled to move to the first storage position P1, and the spoiler device 120 is controlled to move to the second storage position P3). In particular, since the diffuser device 110 is movable between the first storage position P1 and the first unfolded position P2, and the spoiler device 120 is movable between the second storage position P3 and the second unfolded position P4, the vehicle control system 100 further considers the impact of the relative relationship (turning on or turning off) between the diffuser device 110 and the spoiler device 120 on rear-end airflow of the vehicle 50. Therefore, the operation process of the vehicle control system 100 as shown in FIG. 7 is enumerated to control the movement of the diffuser device 110 and the spoiler device 120 in response to the direction of the natural wind. However, the above operation process of the vehicle control system 100 controlling the diffuser device 110 and the spoiler device 120 in response to the direction of the natural wind may be adjusted depend on the conditions such as the specific structures of the diffuser device 110 and the spoiler device 120, the relative relationship between the two, the relative positions between the two, the relative positions between the two and the vehicle body 52, and the appearance of the vehicle 50. In the disclosure, a specific means of controlling the moving positions of the diffuser device 110 and the spoiler device 120 according to the direction of the natural wind is not limited.

In light of the above, in the vehicle control system 100 of this embodiment, the diffuser device 110 may move to the first storage position P1 or the first unfolded position P2 in response to the direction of the natural wind, thereby adjusting the airflow guided by the diffuser device 110 more accurately according to actual conditions. Similarly, the spoiler device 120 may move to the second storage position P3 or the second unfolded position P4 in response to the direction of the natural wind, thereby adjusting the airflow guided by the spoiler device 120 more accurately according to the actual conditions. In particular, during the travelling process of the vehicle 50, according to the direction of the natural wind and driving requirements (e.g., for the setting of the first preset angle, the second preset angle, the preset time, etc.), the control device 140 controls the movement of the diffuser device 110 and the spoiler device 120 according to the direction of the natural wind detected by the natural wind detection device 130. Since the first preset angle and the second preset angle are set to avoid the phenomenon of lowering the air resistance value caused by the cross wind, when the cross wind is large (the angle θ is greater than the second preset angle), preferably, the diffuser device 110 is moved to the first storage position P1 (i.e., the diffuser device 110 is turned off), and the spoiler device 120 is moved to the second unfolded position P4 (i.e., the spoiler device 120 is turned on), thereby further improving the aerodynamic performance of the vehicle 50. In this way, the vehicle 50 may achieve optimal aerodynamic performance regardless of natural wind conditions (the wind speed and wind direction). Accordingly, the vehicle control system 100 may improve the aerodynamic performance of the vehicle 50.

Based on the above, in the vehicle control system of the disclosure, the diffuser device is movably disposed between the first storage position stored in the rear bumper and the first unfolded position protruding from the rear bumper toward the rear of the vehicle. The spoiler device is movably disposed between the second storage position stored in the roof plate and the second unfolded position protruding from the roof plate toward the rear of the vehicle. The natural wind detection device detects the direction of the natural wind relative to the vehicle, and the control device controls the diffuser device and the spoiler device to move independently in response to the direction of the natural wind. Preferably, the control device changes the states of the diffuser device and the spoiler device in response to the direction of the natural wind. The control device controls the diffuser device to move to the first unfolded position and controls the spoiler device to move to the second unfolded position in the first state, controls the diffuser device to move to the first unfolded position and controls the spoiler device to move to the second storage position in the second state, and controls the diffuser device to move to the first storage position and controls the spoiler device to move to the second unfolded position in the third state. In this way, the diffuser device and the spoiler device may respectively move to the respective storage positions or unfolded positions thereof in response to the direction of the natural wind, thereby adjusting the airflow guided by the diffuser device and the spoiler device more accurately according to the actual conditions. Accordingly, the vehicle control system in the disclosure may improve the aerodynamic performance of the vehicle.

Lastly, it is to be noted that: the embodiments described above are only used to illustrate the technical solutions of the disclosure, and not to limit the disclosure; although the disclosure is described in detail with reference to the embodiments, those skilled in the art should understand: it is still possible to modify the technical solutions recorded in the embodiments, or to equivalently replace some or all of the technical features; the modifications or replacements do not cause the essence of the corresponding technical solutions to deviate from the scope of the technical solutions of the embodiments.

What is claimed is:

1. A vehicle control system, comprising:
a diffuser device disposed on a rear bumper of a vehicle and movably disposed between a first storage position stored in the rear bumper and a first unfolded position protruding from the rear bumper toward a rear of the vehicle;
a spoiler device disposed on a roof plate of the vehicle and movably disposed between a second storage position stored in the roof plate and a second unfolded position protruding from the roof plate toward the rear of the vehicle;
a natural wind detection device disposed on the vehicle to detect a direction of natural wind relative to the vehicle; and
a control device disposed on the vehicle and controlling the diffuser device and the spoiler device to move independently in response to the direction of the natural wind.

2. The vehicle control system according to claim 1, wherein
the control device changes states of the diffuser device and the spoiler device in response to the direction of the natural wind, wherein the control device controls the diffuser device to move to the first unfolded position and controls the spoiler device to move to the second unfolded position in a first state, controls the diffuser device to move to the first unfolded position and controls the spoiler device to move to the second storage position in a second state, and controls the diffuser device to move to the first storage position and controls the spoiler device to move to the second unfolded position in a third state.

3. The vehicle control system according to claim 2, wherein
the natural wind detection device detects an angle of the direction of the natural wind relative to a straight direction of the vehicle.

4. The vehicle control system according to claim 3, wherein
the natural wind detection device detects a pressure value of the natural wind, and
the angle of the direction of the natural wind relative to the straight direction of the vehicle is obtained by calculating the pressure value.

5. The vehicle control system according to claim 3, wherein
when the angle of the direction of the natural wind relative to the straight direction of the vehicle is less than a first preset angle, the control device controls the diffuser device to move to the first unfolded position and controls the spoiler device to move to the second storage position,
when the angle of the direction of the natural wind relative to the straight direction of the vehicle is greater than the first preset angle and less than a second preset angle, the control device controls the diffuser device to move to the first unfolded position and control the spoiler device to move to the second unfolded position, and
when the angle of the direction of the natural wind relative to the straight direction of the vehicle is greater than the second preset angle, the control device controls the diffuser device to move to the first storage position and controls the spoiler device to move to the second unfolded position.
